(19) United States
(12) Patent Application Publication
(10) Pub. No.: US 2017/0355581 A1
(43) Pub. Date: Dec. 14, 2017

(54) MULTIPLE SPEED JACK HANDLE

(71) Applicant: Michael H. Dick, Clear Lake, IA (US)

(72) Inventor: Michael H. Dick, Clear Lake, IA (US)

(21) Appl. No.: 15/622,517

(22) Filed: Jun. 14, 2017

Related U.S. Application Data
(60) Provisional application No. 62/349,770, filed on Jun. 14, 2016.

(51) Int. Cl. B66F 13/00; G05G 1/10; G05G 1/08

(52) U.S. Cl. CPC B66F 13/00; G05G 1/085; G05G 1/10

(57) ABSTRACT

A multiple speed jack handle system has a handle, an elongated rod, and a jack. The handle extends vertically from a first end to a first elbow, from the first elbow horizontally along a shaft to a second elbow and then vertically from the second elbow to a second knob. A first knob is connected to the shaft between the first and second elbows.

### CROSS REFERENCE TO RELATED APPLICATION

This application claims the benefit to Provisional Application U.S. Ser. No. 62/349,770 filed on Jun. 14, 2016.

### BACKGROUND OF THE INVENTION

This invention relates to a jack handle. More specifically and without limitation, this invention is directed towards a system for a multiple speed jack handle.

Jack handles are old and well known in the art. Conventionally, jacks have a single point of rotation that is used to raise or lower a jack. While this arrangement is effective it has a number of disadvantages. Namely, this limits the speed in which a jack can be raised or lowered due to the rotational circumference the handle must travel to complete a single revolution. The inability to vary the rotational circumference can result in the amount of energy and effort exerted to raise or lower a jack to be more than is necessary. Similarly, the rotational circumference a user must cover is directly related to the amount of time it takes to raise and lower a jack.

Thus it is a primary objective of the invention to provide a multiple speed jack handle that improves upon the state of the art.

Another object of the invention is to provide a multiple speed jack handle that increases the speed of raising and lowering a jack.

Yet another object of the invention is to provide a multiple speed jack handle that is easy to use.

Yet another object of the invention is to provide a multiple speed jack handle that is adaptable to existing jacks.

Another object of the invention is to provide a multiple speed jack handle that is inexpensive.

Another object of the invention is to provide a multiple speed jack handle that is durable.

Another object of the invention is to provide a multiple speed jack handle that has a long and useful life.

Another object of the invention is to provide a multiple speed jack handle that has an intuitive design.

Another object of the invention is to provide a multiple speed jack handle that has a minimum number of parts.

Another object of the invention is to provide a multiple speed jack handle that is simple.

These and other objects, features, or advantages of the inventions will become apparent from the specification and claims.

### SUMMARY OF THE INVENTION

A multiple speed jack handle system is presented. The jack handle system includes a handle a first elbow and a second elbow with a shaft connected there between. A first knob is adjustably positioned on the shaft between the first elbow and the second elbow. A second knob is attached to the second elbow. An elongated rod is connected to the first elbow. The elongated rod connects to a jack. In this way, presented is a multiple speed jack handle that allows for faster or slower rotation of the jack handle, which in turn increases or decreases how quickly the jack is raised or lowered.

### BRIEF DESCRIPTION OF THE DRAWINGS

FIG. 1 is a perspective exploded view of the multiple speed jack handle system; and

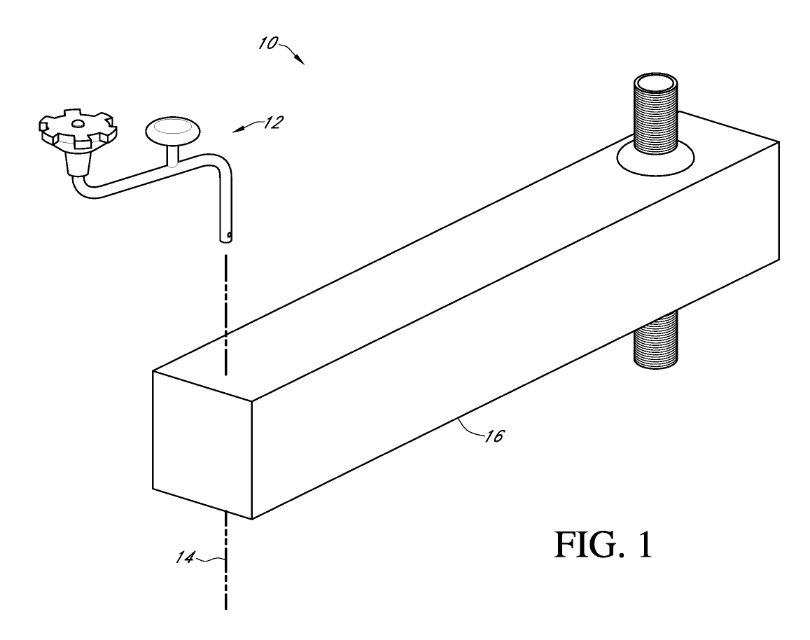

FIG. 2 is a perspective view of the multiple speed jack handle system.

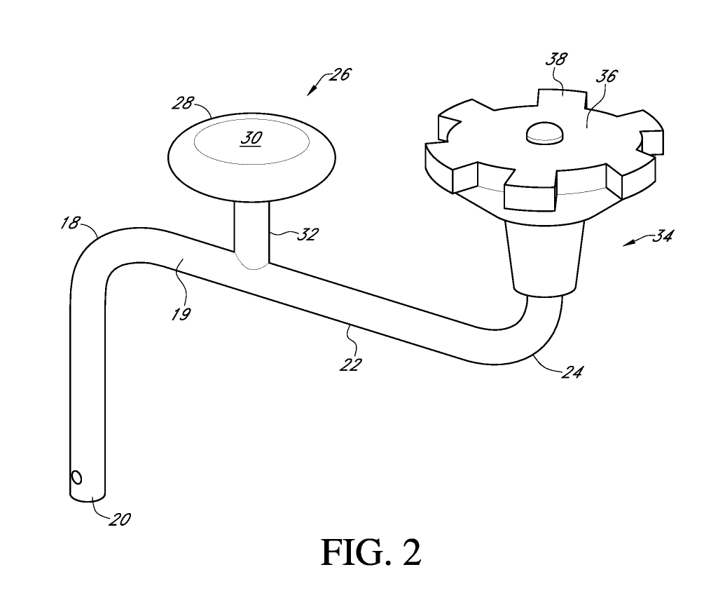

### DETAILED DESCRIPTION OF THE PREFERRED EMBODIMENT

With reference to the figures, a multiple speed jack handle system 10 is presented. In the embodiment shown, the jack handle system 10 includes a handle 12, an elongated rod 14, and a jack 16. The handle 12 has a first elbow 18 having an end 20. Preferably the first elbow 18 bends at a right angle but the bend can be of any angle. The first elbow 18 terminates into shaft 22 which terminates in a second elbow 24 that bends at generally a right angle opposite of the first elbow 18. In an alternative arrangement, the first elbow 18, shaft 22, and second elbow 24 are connected in any manner such as permanent connection by welding, by formation out of a single piece of material, snap fitting, frictional engagement, or the like.

A first knob 26 is attached to the top of the shaft 22 between the first elbow 18 and the second elbow 24. The first knob 26 can be attached to the shaft 22 in any manner such as welding, unibody design, snap fitting, frictional engagement or the like. In one embodiment, the first knob 26 is positioned 2.5 inches from the first elbow 18. Alternatively, knob 26 is slidably attached to shaft 32 with a clamp or the like. The first knob 26 has a grip 28 that is circular and has a concave surface 30 to allow for easy gripping. The grip 28 is connected to a stem 32 that attaches to the shaft 22 of the handle 12. In alternative arrangements the grip 28 can be of any shape and size. Alternatively, the first knob 26 is slidably attached to shaft 22 in any conventional manner.

A second knob 34 is attached to the end of elbow 24. In the embodiment shown, the second knob 34 is connected to the second elbow 24, but can also be directly attached to the shaft 22. The second knob 34 is attached in any manner such as welding, unibody design, snap fitting, frictional engagement or the like. In the arrangement shown, the second knob 34 has a grip 36 with a plurality of ridges 38 that a user can interlock their fingers with. In alternative embodiments the grip 36 can be of any shape and size.

The top of the elongated rod 14 connects to the handle 12 at the second end 20 of the first elbow 18. In the embodiment shown, the rod 14 is connected to the handle 12 by snap fit, but can alternatively be connected in any manner including permanent connection by welding, by formation out of a single piece of material, snap fitting, frictional engagement, or the like. The bottom of elongated rod 14 is attached to the jack 16. In embodiment shown, the rod 14 extends through the jack 16.

In Operation: A user inserts the elongated rod 14 into the jack 14. Next, the user attaches the handle 12 to the opposite end of the rod 12. To raise or lower the jack 14, the user turns the rod 14 by using either the first knob 26 or the second knob 34 of the handle 12. If the user wants to quickly raise or lower the jack 14 the user grips the grip 28 of the first knob 26 and begins to rotate the handle 12. Because the first knob 26 is positioned nearer to the rod 14 the rotational circumference of using the first knob 26 is shorter. This in turn requires less distance to be covered while turning the handle 12. As such, the user is able to turn the handle 12 faster and raise or lower the jack 14 more quickly.

Alternatively, the user can adjust the first knob along shaft 22 to a desired position or use the second knob 34 by gripping the grip 36 and rotating the handle 12. The second knob 34 is positioned further from the rod 14, which in turn increases the rotational circumference. The increased distance that must be covered to complete a revolution increases the time to raise or lower the jack 16.

From the above discussion, it will be appreciated that the multiple speed jack handle system 10 presented improves upon the state of the art. That is, the customizable hand tool system presented increases the speed of raising and lowering a jack; is easy to use; is adaptable to existing jacks; is inexpensive, durable, and has a long and useful life; has an intuitive design; is simple; and has a minimum number of parts.

It will be appreciated by those skilled in the art that other various modifications could be made to the device without parting from the spirit and scope of this invention. All such modifications and changes fall within the scope of the claims and are intended to be covered thereby.

What is claimed is:

1. A multiple speed jack handle system comprising:
a handle that includes a first elbow and a second elbow;
a shaft extending between the first elbow and the second elbow;
a first knob connected to the shaft; and
a second knob attached to an end of the second elbow.

2. The system of claim 1 wherein the first knob is slidably connected to the shaft.

3. The system of claim 1 wherein the first knob has a grip with a concave surface and a stem.

4. The system of claim 1 wherein the second knob has a grip with ridges.
